(19) United States
(12) Patent Application Publication
(10) Pub. No.: US 2015/0150004 A1
(43) Pub. Date: May 28, 2015

(54) DETERMINING VIRTUAL MACHINE PLACEMENT

(71) Applicants: Patrick Charles McGeer, Orinda, CA (US); Dejan S. Milojicic, Palo Alto, CA (US)

(72) Inventors: Patrick Charles McGeer, Orinda, CA (US); Dejan S. Milojicic, Palo Alto, CA (US)

(21) Appl. No.: 14/396,321

(22) PCT Filed: Apr. 30, 2012
(86) PCT No.: PCT/US2012/035810

§ 371 Date: Oct. 22, 2014

(51) Int. Cl. G06F 9/455

(52) U.S. Cl. CPC G06F 9/45558; G06F 2009/4557
USPC 718/1

(57) ABSTRACT

A technique includes providing a candidate configuration for virtual machines specifying where the virtual machines are stored in a plurality of hardware containers. The candidate configuration is selectively modified to generate another candidate configuration specifying where the virtual machines are stored in the plurality of hardware containers based at least in part on communication capacities that are associated with the hardware containers. The placement of the virtual machines is determined based at least in part on the selective modification.

### BACKGROUND

Virtual machines can be provided in a computer to enhance flexibility and utilization. A virtual machine typically refers to some arrangement of components (software and/or hardware) for virtualizing or emulating an actual computer, where the virtual machine can include an operating system and software applications. Virtual machines can allow different operating systems to be deployed on the same computer, such that applications written for different operating systems can be executed in different virtual machines (that contain corresponding operating systems) in the same computer. Moreover, the operating system of a virtual machine can be different from the host operating system that may be running on the computer on which the virtual machine is deployed.

In addition, a greater level of isolation is provided between or among applications running in different virtual machines. In some cases, virtual machines also allow multiple applications to more efficiently share common resources (processing resources, input/output or I/O resources, and storage resources) of the computer.

### BRIEF DESCRIPTION OF THE DRAWINGS

FIG. 1 is a block diagram of a system of physical machines that are interconnected by a network according to an example implementation.

FIG. 2 is a block diagram of a network in which virtual machines are distributed among bins according to an example implementation.

FIGS. 3, 4 and 5 are flow diagrams depicting techniques to determine virtual machine placement according to example implementations.

FIG. 6 is a flow diagram depicting a technique to update virtual machine placement in response to a newly added job according to an example implementation.

FIG. 7 is a flow diagram depicting a technique to update virtual machine placement in response to an exiting job according to an example implementation.

FIG. 8 is a flow diagram depicting a technique to perform minimum bin packing according to an example implementation.

FIG. 9 is a flow diagram depicting a technique to minimize a number of bins into which virtual machines are placed according to an example implementation.

FIG. 10 is a flow diagram depicting a technique to place virtual machines in the available bins of smallest size according to an example implementation.

### DETAILED DESCRIPTION

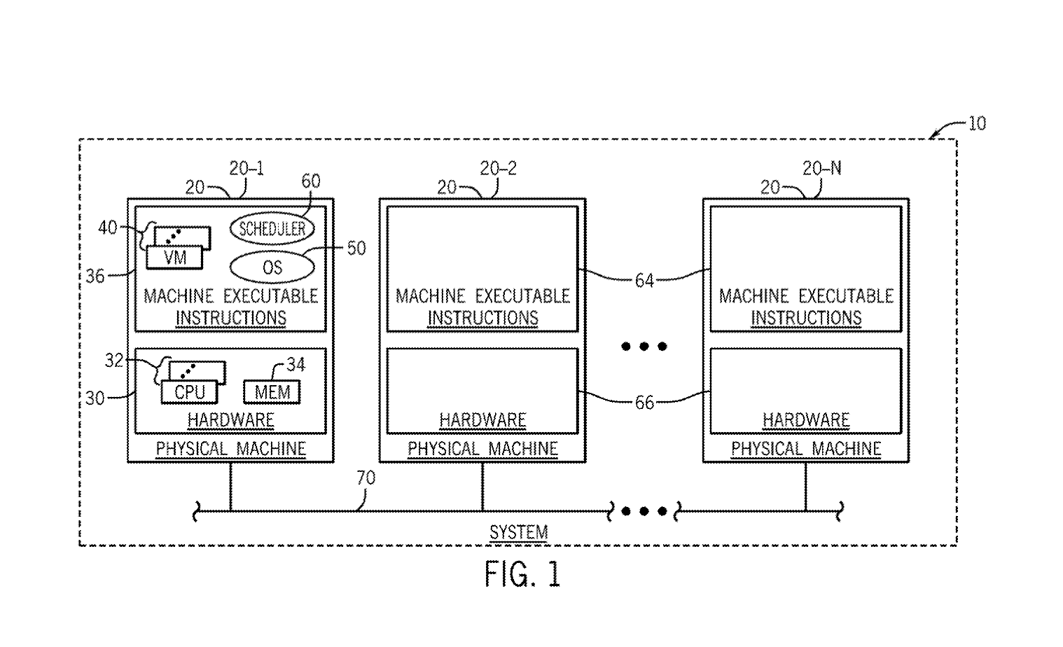

Referring to FIG. 1, a system 10 in accordance with example implementations includes N physical machines 20 (physical machines 20-1, 20-2 . . . 20-N, being depicted in FIG. 1 as non-limiting examples), which are interconnected by a network 70. As examples, the network 70 may be a local area network (LAN), a wide area network (WAN), the Internet or any other type of communication link. The network 70 may include system buses or other fast interconnects, which are not depicted in FIG. 1. The physical machines 20 may be located within one cabinet (or rack), or alternatively, the physical machines 20 may be located in multiple cabinets (or racks).

As non-limiting examples, the system 10 may be an application server farm, a cloud server farm, a storage server farm (or storage area network), a web server farm, a switch, a router farm, and so forth. Although three physical machines 20 are depicted in FIG. 1 for purposes of a non-limiting example, it is understood that the system 10 may contain fewer or more than three physical machines 20, depending on the particular implementation.

As non-limiting examples, each of the physical machines 20 may be a computer (an application server, a storage server, a web server, etc., for example), a communications module (a switch, a router, etc.) and/or another type of machine. In general, the language “physical machine” refers to the machine as being an actual machine, which is made up of software (i.e., machine executable instructions) and hardware. Moreover, although each of the physical machines 20 as depicted in FIG. 1 as being contained within a box, this is a schematic representation, as a particular physical machine 20 may be a distributed machine, which has multiple nodes that provide a distributed and parallel processing system.

Each physical machine 20 provides a platform for the installation of one or multiple virtual machines. In this manner, a given physical machine 20 may host, or contain, one or multiple virtual machines (such as, for example, virtual machines 40, which are depicted in FIG. 1 as residing on the physical machine 20-1); and, in general, the virtual machine(s) on each physical machine 20 may be different to serve different purposes.

A virtual machine refers to some partition or segment (made of software and/or hardware) of the physical machine 20, which is provided to virtualize, or emulate, a physical machine. From the perspective of a user, a virtual machine has the same appearance as a physical machine. As an example, a particular virtual machine may include one or more software applications, an operating system and one or more device drivers.

The operating systems that are part of the corresponding virtual machines within a physical machine 20 may be different types of operating systems or different versions of an operating system. This allows software applications designed for different operating systems to execute on the same physical machine 20.

The virtual machines within a physical machine 20 are designed to share the physical resources of the physical machine 20. As a more specific example, exemplary physical machine 20-1 includes hardware 30, which, in turn, includes one or more central processing units (CPUs) 32, a memory 34 (a system memory, for example) and possibly other hardware components, such as a network interface, a display driver, and so forth. It is noted that these components are listed as mere examples, as the hardware 30 may include other and/or different physical components, such as a storage area network (SAN) interface, as a non-limiting example. The other physical machines 20 (such as the physical machine 20-2 and the physical machine 20-N, for example, which are also depicted in FIG. 1) may contain similar hardware.

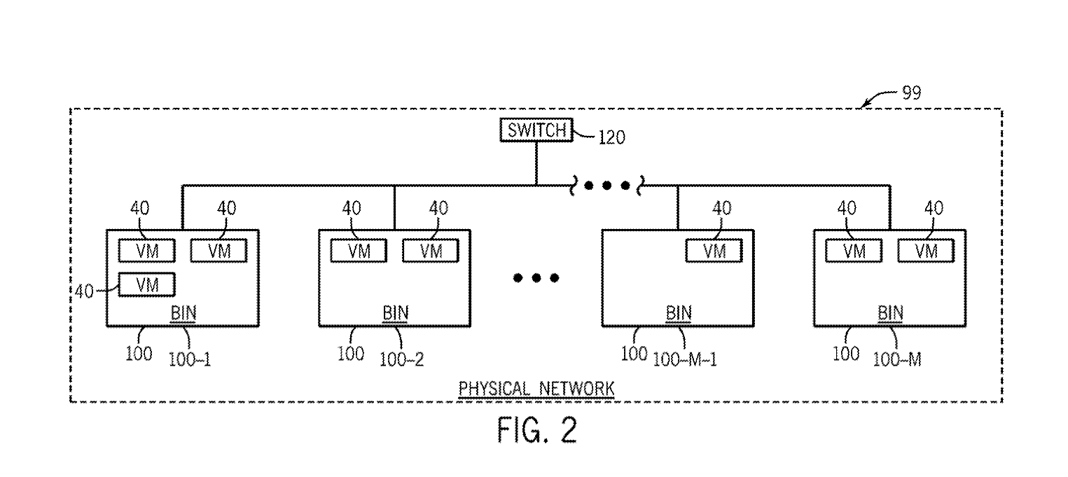

Using the physical machine 20-1 as an example, in addition to hardware, the physical machine 20-1 contains other software components (i.e., components formed in part by machine executable instructions), such as the virtual machines 40, an operating system 50. The physical machine 20-1 further includes a set of machine executable instructions that form a “scheduler 60” to determine a virtual machine placement, as further described herein. It is noted that the physical machine 20-1 may contain other software components that are not depicted in FIG. 2, such as, for example, a virtual machine manager (VMM), or hypervisor, which manages the sharing of the virtual machines by the physical resources of the physical machine 20. In general, the VMM virtualizes the physical resources, including the hardware 30, of the physical machine 20-1. Also, the VMM intercepts requests for resources from the operating systems in the respective virtual machines 40 so that proper allocation of the physical resources of the physical machine 20-1 may be performed. As non-limiting examples, the VMM may manage memory accesses, input/output (I/O) device accesses and CPU scheduling for the virtual machines 40. The VMM allows multiple operating systems, called guest operating systems, to run on the same host computer. Effectively, the VMM provides an interface between the operating system of each virtual machine and the underlying hardware 30 of the physical machine 20-1. The interface provided by the VMM to an operating system of a virtual machine is designed to emulate the interface that is provided by the actual hardware 30 of the physical machine 20-1.

Similar to the physical machine 20-1, the other physical machines 20-2 . . . 20-N of the system 10 may contain similar hardware 66 and machine executable instructions 64, in accordance with example implementations.

Each virtual machine 40 is associated with a particular hardware container, called a “bin” herein. In this regard, the bins represent partitions (overlapping and/or non-overlapping partitions, depending on the particular implementation) of the hardware that contains, or hosts, the virtual machines 40. For the example of FIG. 1, the virtual machines 40 may be assigned or placed in various hardware containers, or bins, of the system 10. As a non-limiting example, the physical machines 20 may each be regarded as a “bin.” However, in general, a bin may be a computer, a switch, a combination of a computer and a switch, one or multiple ports of a switch, and so forth. In accordance with example implementations that are disclosed herein, a “bin” refers to a container of virtual machines with a fixed capacity (maximum number of virtual machines) and fixed maximum network bandwidth.

As a more specific example, FIG. 2 depicts an example network 99 that contains multiple bins 100 (bins 100-1, 100-2 . . . 100-M−1, 100-M, being depicted as non-limiting examples). For the example network 99, a bin 100 is a physical machine, and the bins 100 are coupled together by a network switch 120. As shown in FIG. 2, each bin 100 may contain one or multiple virtual machines 40. In general, a given bin 100 has a fixed size (i.e., it is capable of accommodating a fixed number of virtual machines 40), and there is a finite traffic capacity between a given pair of bins 100. The bin sizes may vary or may be the same, depending on the particular implementation. As shown in FIG. 2, by way of example, the bin 100-1 contains three virtual machines 40, the bin 100-2 contains two virtual machines 40, and so forth.

Multiple virtual machines 40 may be associated with performing a certain job; and in the performance of a given job, different pairs of the virtual machines 40 communicate with each other. Each virtual machine pair may have an associated desired communication bandwidth, or traffic, minimum to support their inter-communication. Techniques and systems are disclosed herein for purposes of determining the placement, or distribution, of the virtual machines 40 among the bins 100 such that the virtual machines 40 are placed in the bins 100 in a distribution that allows all inter-virtual machine traffic to be accommodated, while constraining the number of virtual machines 40 assigned to a particular bin 100 to be less than the total size of the bin 100. Such a placement permits an efficient use of a minimum number of bins (i.e., a minimum number of physical machines and switches, for example) in a data center (for example) to accommodate a given load of virtual machines with certain communication requirements, thereby allowing the remaining bins (i.e., the remaining physical machines, switch ports, switches, and so forth) to accommodate more jobs or be turned off for purposes of conserving power.

As a more specific example, using the techniques and systems that are disclosed herein, a virtual network of virtual machines may be mapped onto a physical network of physical machines in a manner that maintains a guaranteed bandwidth between the physical machines, as specified by a service level agreement (SLA). For this example, the physical network of physical machines may be a cloud network. The bin in this case refers to a physical machine, and the size of the physical machine refers to the maximum number of virtual machines, which may be simultaneously hosted on the machine. This maximum number may be selected by a system administrator and may be dependent on a number of factors, such as available memory, the number of processing cores of the physical machine, and so forth.

Another application involving the mapping, or placement, of a virtual network of virtual machines onto a physical network of physical machines is network testbed mapping. In the regard, in this application, a virtual network of virtual machines is mapped onto a physical network of physical machines, while maintaining guaranteed bandwidth on the links. The network testbed facility may be used to run network experiments such as, for example, testing the performance properties of new network protocols. Fidelity of the mapping of the virtual to the physical network may be relatively important for such purposes of establishing experimental validity and establishing reliability of the results.

As further described herein, the systems and techniques that are disclosed herein may be used to further map a virtual network of virtual machines onto a physical network of physical machines, which implement a cloud service, while conserving the amount of consumed power in the physical network.

In accordance with an example implementation, for purposes of determining an optimum configuration for placing a group of the virtual machines 40 (i.e., determining a configuration for distributing the virtual machines 40 among the bins 100), initially, the virtual machines 40 may be placed into the bins at random, or by another technique (such as the Eigenvector method, for example). Using this initial, candidate configuration as a starting point, one or multiple alternate candidate configurations are evaluated for purposes of determining a particular final configuration for placing the virtual machines 40, taking into account the communication capacities among the bins 100, the bin size, power consumption desires, and so forth.

More specifically, a given candidate configuration for placing virtual machines among available bins is evaluated, pursuant to the techniques and systems disclosed herein, by evaluating the gain, or benefit (called “benefit(i,a,b)” below), of moving a given virtual machine i from its current bin a to another bin b:

benefit(i,a,b)=Σ_{kεneighbors(i)}(cap(b,bin(k))−cap(a,bin(k)))*com(i,k), Eq. 1

where “k” represents an index to represent the virtual machines k that communicate with the virtual machine i; “(cap(b,bin(k))” represents the communications capacity between bin b (i.e., the new bin) and bin k; “cap(a,bin(k))” represents the communications capacity between bin a and bin k; and “com(i,k)” represents the communication requirement for communications between virtual machine i and virtual machine k.

In Eq. 1, com(i,k) captures the desired communication bandwidth between virtual machines i and k. It is noted that cap(a, a)=∞ (in practice, a sufficiently large number that cap(a,a)−cap(a,b) is large and positive for each b≠a). Hence, in mathematical terms, cap(b,bin(k))−cap(a, bin(k)) is positive if there is greater communications capacity between b and bin(k), i.e., if the available physical capacity between i and k increases. The value of this gain depends on how much capacity is desired between the virtual machines i and k, and this is captured in the function com(i,k): multiplying by this term weights the value of this proposed move from the perspective of this pair of virtual machines.

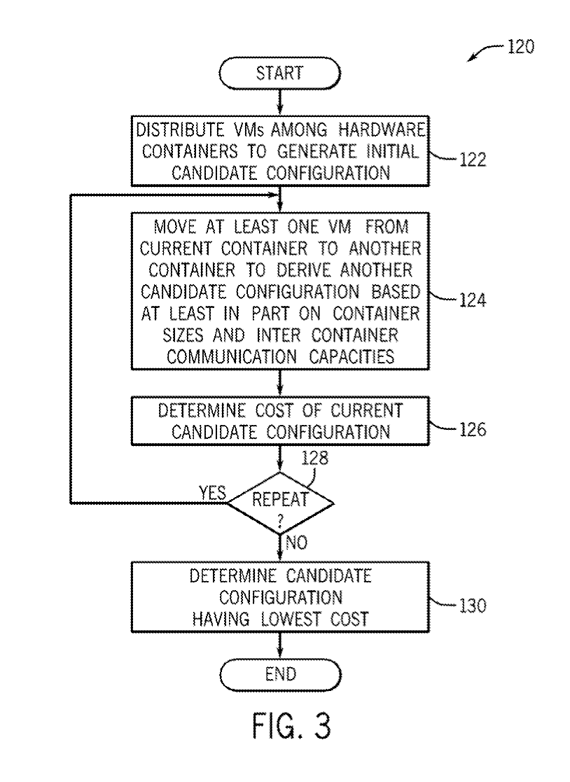

In accordance with an exemplary implementation, a technique 120 that is set forth in FIG. 3 may be used (by the scheduler 60 of FIG. 1, for example) for purposes of evaluating candidate configurations for placing virtual machines among bins, or hardware containers, to determine a final virtual machine placement configuration. Pursuant to the technique 120, virtual machines are distributed (block 122) among hardware containers to generate an initial candidate configuration. Next, pursuant to the technique 120, at least one virtual machine is moved (block 124) from its current container to another container to derive another candidate configuration based at least in part on container sizes and inter-container communication capacities.

The cost of the current candidate configuration is then determined, pursuant to block 126. More specifically, in accordance with an exemplary implementation, a benefit of the move described in block 124, such as the benefit determined from Eq. 1, is determined and subtracted from a total cost associated with the previous candidate configuration to determine the cost of the current candidate configuration. This cost, in turn, is compared to previously determined costs associated with other candidate configurations to determine whether the current cost is the best cost. If all of the candidate configurations have been evaluated, then the candidate configuration that has the lowest cost is determined or identified, pursuant to block 130. Otherwise, if more candidate configurations may be determined, the technique 120 includes repeating block 124 (see decision block 128) to derive at least one other candidate configuration.

As a more specific and non-limiting example, a technique 200 of FIG. 4 may be employed (by the scheduler 60 of FIG. 1, for example) for purposes of determining the placement of virtual machines among a group of bins. Pursuant to the technique 200, the virtual machines are initially distributed (block 202) in the bins in an initial candidate configuration. Next, the technique 200 uses an iterative process to evaluate candidate configurations derived from this initial candidate configuration. First, however, the technique 200 includes, for each virtual machine, determining (block 204) the associated benefits of moving each virtual machine from its current bin to other bins. In this regard, as a more specific example, in accordance with some implementations, block 204 involves calculating the benefits of Eq. 1 of moving each virtual machine. These benefits, in turn, may be stored in one or multiple arrays, which are indexed by the virtual machine and the bin in which the virtual machine is currently stored. It is noted that as the candidate configurations are derived (and correspondingly, virtual machines are moved), the array(s) are modified to reflect the updated benefits and updated bins into which the virtual machines have been moved.

Using the derived benefits stored in the array(s), the technique 200 creates (block 206) a move array. In general, the move array sets forth the “best” next virtual machine move, considering the virtual machines in a particular bin. In this manner, if a virtual machine move is being contemplated for a given bin, the move array sets forth the best virtual machine move from the bin that results in the greatest benefit (as determined from Eq. 1, for example).

In accordance with an example implementation, the technique 200 creates a particular new candidate configuration from a prior candidate configuration by making a single virtual machine move from the bin in which the virtual machine currently resides into a target bin. Thus, using an existing candidate configuration, a single virtual machine is moved from one of the bins into another bin to create the next candidate configuration. Moreover, in accordance with an example implementation, the technique 200 moves a given virtual machine into a target bin once and selects a virtual machine for the next move from the target bin.

Turning now to the more specific details, pursuant to the technique 200, the technique 200 determines (decision block 208) whether another move is to be performed. In general, another move may be performed if 1. the movement of a previously-unmoved virtual machine is the best move; and 2. the move may be made into a bin that has sufficient capacity.

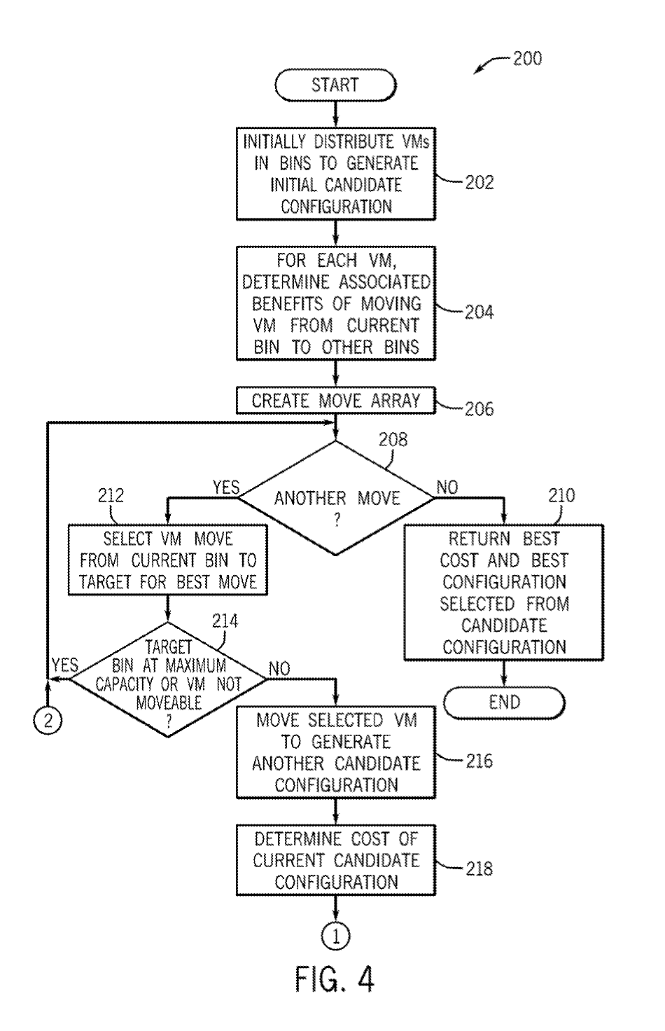

If another move is to be made, the next best virtual machine move is selected (block 212) from the current bin (i.e., the previous target bin) and a determination is made (decision block 214) whether the target bin is at the maximum capacity or the virtual machine is not moveable. If another move may be made, then the selected virtual machine is moved, pursuant to block 216, and the cost of the resulting current candidate configuration is determined, pursuant to block 218. Referring to FIG. 5 in conjunction with FIG. 6, if the current move is the best move (decision block 220), then the best cost and best configuration are updated, pursuant to block 222.

Next, pursuant to the technique 200, the benefits are updated, pursuant to block 224. In this manner, due to the move, the technique 200 includes re-determining the benefits for the virtual machines that communicate with the moved virtual machine. Consequently, the technique 200 includes updating (block 226) the move array.

If another move is not to be made (block 208), then the technique 200 includes returning (block 210) the best cost and the best configuration.

In accordance with example implementations, the techniques 120 and/or 200 may be used in connection with an online processing center in which new jobs are mapped into an existing assignment as the jobs enter into the system. As non-limiting examples, the system may be a cloud system or a network testbed, which is, in general, continuously available, as jobs stream in and exit the system. The techniques 120 and/or 200 may be used for purposes of mapping jobs into the system upon entry, thereby reducing the capacity of communication links and available bin sizes as directed by the returned configuration. On exit, these capacities and sizes are restored.

As a more specific example, FIG. 6 depicts a technique 300, which may be employed for purposes of adding one or multiple virtual machines (as identified by a new job request) in such a system. Referring to FIG. 6 in conjunction with FIG. 1, pursuant to the technique 300, the scheduler 60 (see FIG. 1) determines (block 302) the best configuration for the new job. Thus, in accordance with example implementations, the techniques 120 and/or 200 may be employed for this purpose. Next, the scheduler 60 updates (block 304) the bin size and communication capacities to reflect the new job and subsequently performs (block 306) one or multiple migrations of the newly-added virtual machine(s) to achieve the best configuration determined in block 302.

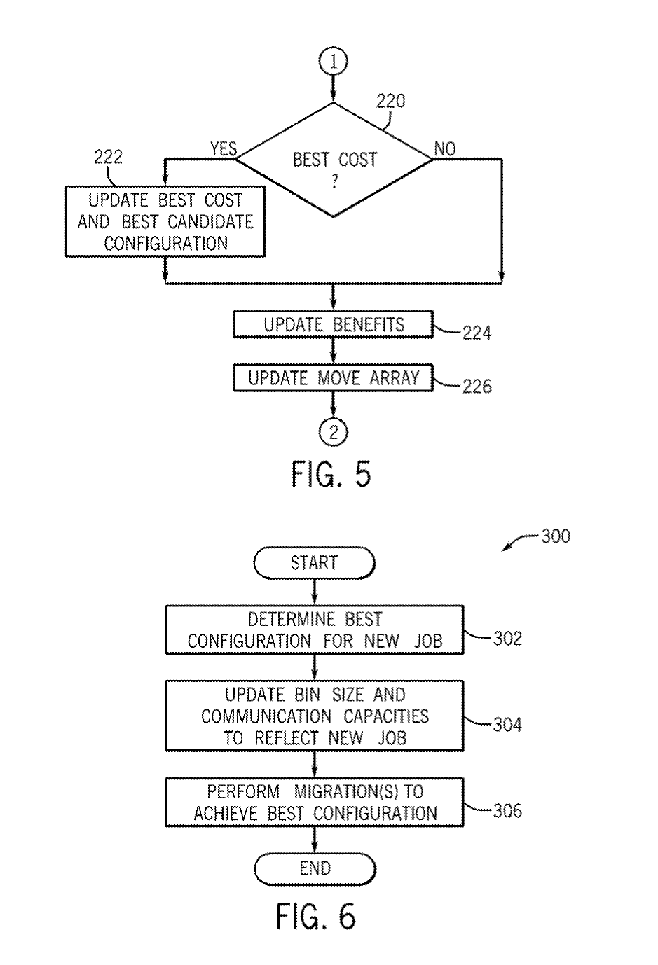

As another non-limiting example, the scheduler 60 may perform a technique 350 in connection with FIG. 7 when a particular job exits the system. Referring to FIG. 1 in conjunction with FIG. 7, pursuant to the technique 350, the scheduler 60 determines (block 352) the current configuration and updates (block 354) the bin size and communication capacities to reflect the exiting job. The one or multiple virtual machines that correspond to the exiting job are then removed and the current configuration is updated, pursuant to block 356.

The techniques 120 and 200 minimize the consumed communication bandwidth subject to a capacity (bin size) constraint. In accordance with further implementations, the techniques 120 and/or 200 may be inverted for purposes of either minimizing the maximum number of virtual machines that are packed into a bin subject to a communications constraint or minimize the number of bins that are used in packing subject to a communications constraint. This latter constraint may be of particular interest when computation costs are dominant, such as in, for example, a power minimization application. More specifically, for power minimization, minimizing the number of bins, in turn, minimizes such factors as the number of physical machines that are employed, the number of switches or switch ports that are employed, and so forth. Minimizing the maximum number of items packed into a bin may be of particular interest when new jobs are expected to consume resources uniformly across a cluster of physical machines and additional capacities are expected to be consumed across the cluster as new jobs are added.

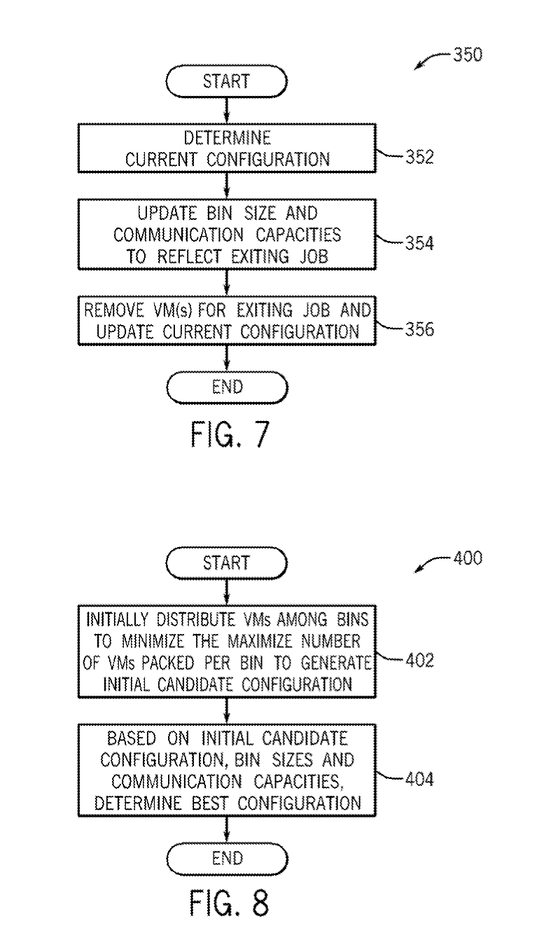

Referring to FIG. 8 in conjunction with FIG. 1, for purposes of minimizing the maximum number of virtual machines that are packed into a given bin, the scheduler 60 may use a technique 400 that is depicted in FIG. 8, in accordance with an example implementation. Pursuant to the technique 400, the scheduler 60 initially distributes the virtual machines among the bins to maximize the number of bins to derive an initial candidate configuration, pursuant to block 402. Using this initial candidate distribution (which corresponds to block 122 of the technique 120 or block 202 of the technique 200), the scheduler 60 applies the technique 120 and/or 200 for purposes of determining the best configuration. In this manner, based on the initial candidate configuration, bin sizes and communication capacities, the scheduler 60 determines the best configuration, pursuant to block 404.

Minimizing the number of used bins that are subject to a communications constraint involves two issues. The first issue concerns selecting the right subset of bins. In other words, assuming that the virtual machines are to be packed into m bins, a decision is made regarding which m of the n bins should be used. The second issue involves selecting the best move, not simply the best move away from the bin that just received a virtual machine.

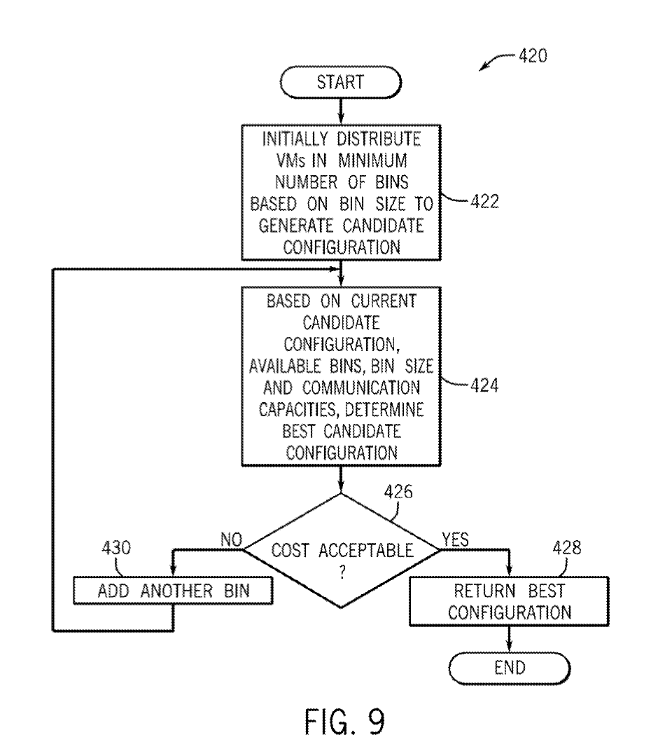

For the first issue, the best m of n subset is problem independent if the bins have unit weights and interconnections between the bins are uniform. For this case, in which all subsets of m bins are identical, the scheduler 60 may apply a technique 420 that is depicted in FIG. 9. Referring to FIG. 9 in conjunction with FIG. 1, pursuant to the technique 420, the scheduler 60 initially distributes the virtual machines into a minimum number of bins based on bin size, pursuant to block 422 to generate an initial candidate configuration. Using this initial candidate configuration, the scheduler 60 applies the technique 120 or 200. In this manner, the scheduler 60 determines the best configuration based on the current configuration, the bin size and communication capacities, pursuant to block 424. The scheduler 60 next determines (decision block 426) whether the cost associated with the best configuration determined in block 424 is acceptable; and if so, the scheduler 60 returns the best configuration, pursuant to block 428. Otherwise, if the cost is not acceptable (as determined in decision block 426), the scheduler 60 adds (block 430) another bin and control returns to block 424 for another duration. It is noted that the order for the technique 420 is 0(∥bins∥²∥VMs∥).

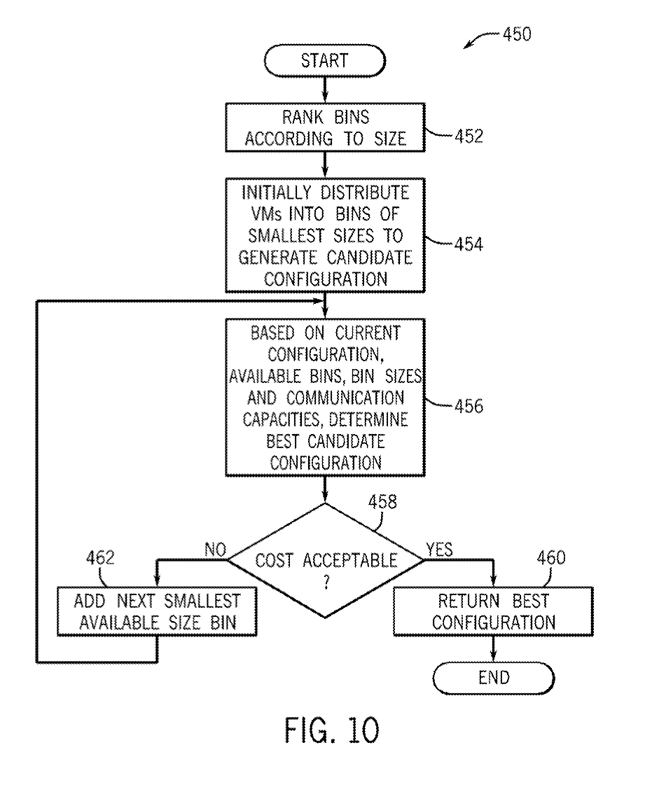

When the bins do not have equal sizes and inter-communication capacities, the scheduler 60 may perform a technique 450 that is depicted in FIG. 10. Referring to FIG. 1 in conjunction with FIG. 10, pursuant to the technique 450, the scheduler 60 initially ranks (block 452) the bins according to size and initially distributes (block 454) the virtual machines into bins of the smallest size to generate an initial candidate configuration. The scheduler 60 next performs an iterative process for purposes of selecting the smallest number of bins based on cost. More specifically, in accordance with exemplary implementations, the scheduler 60 determines the best configuration based on the current configuration, bin sizes and communication capacities, pursuant to block 456. If the cost is acceptable (decision block 458), then the scheduler 60 returns the best configuration, pursuant to block 460. Otherwise, the scheduler 60 adds (block 462) the next smallest available size bin, and control returns to block 456. In general, the order of the technique 450 is 0(∥bins∥²∥VMs∥).

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
providing a first candidate configuration for virtual machines specifying where the virtual machines are stored in a plurality of hardware containers;
determining a benefit gained by modifying the first candidate configuration to change a hardware container from the plurality of hardware containers where at least one of the virtual machines is stored based at least in part on communication capacities associated with the plurality of hardware containers;
selectively modifying the first candidate configuration to generate a second candidate configuration specifying where the virtual machines are stored in the plurality of hardware containers based at least in part on the determined benefit; and
determining placement of the virtual machines based at least in part on the selective modification.

2. The method of claim 1, wherein selectively modifying the first candidate configuration comprises generating the second candidate configuration, the method further comprising:
determining a benefit gained by modifying the second candidate configuration to change the hardware container where at least one of the virtual machines is stored;
selectively modifying the second candidate configuration to generate a third candidate configuration specifying where the virtual machines are stored in the plurality of hardware containers based at least in part on the determined benefit gained by modifying the second candidate configuration.

3. The method of claim 1, further comprising:
selecting one of the first and second configurations based on costs associated with the first and second configurations; and
selectively migrating at least one of the virtual machines based at least in part on the selected configuration.

4. The method of claim 1, wherein the first configuration specifies storing at least two of the plurality of virtual machines in one of the hardware containers, the method further comprising:
determining a benefit gained by moving each of the at least two virtual machines where the virtual machine is specified as being stored by the first configuration to another one of the hardware containers, and
wherein the determining the benefit gained by modifying the first configuration comprises selecting one of the determined benefits gained by moving each of the at least two virtual machines.

5. The method of claim 1, further comprising further basing the benefit gained on at least one of sizes of the hardware containers and communication requirements of the virtual machines.

6. The method of claim 1, further comprising constraining the selective modification to minimize a first number of the hardware containers in which the virtual machines are stored based at least in part on a cost derived from the determined benefit, the first number being less than a greater number of available hardware containers.

7. The method of claim 1, further comprising constraining the selective modification to maximize a distribution of the virtual machines across the hardware containers based at least in part on a cost derived from the determined benefit.

8. The method of claim 1, wherein the selective modification comprises selectively expanding a number of the plurality of hardware containers based at least in part on a cost derived from the determined benefit.

9. The method of claim 1, further comprising:
ranking a group of available hardware containers according to size, the group of available hardware containers comprising the plurality of hardware containers,
wherein the selective modification comprises selectively expanding a number of the plurality of hardware containers based at least in part on the cost derived from the determined benefit and the ranking.

10. An apparatus comprising:
an interface to receive a request indicative of a job; and
a processor-based scheduler to, in response to the request, determine a configuration specifying where a plurality of virtual machines are stored in a plurality of hardware containers, the scheduler being adapted to:
generate at least one candidate configuration specifying where the plurality of virtual machines are stored in the plurality of hardware containers;
selectively modify the at least one candidate configuration to change a hardware container from the plurality of hardware containers where at least one of the virtual machines is specified as being stored based at least in part on communication capacities associated with the plurality of hardware containers; and
determine the configuration specifying where the plurality of virtual machines are stored in the plurality of hardware containers based at least in part on the selective modification.

11. The apparatus of claim 10, wherein the hardware containers are associated with at least one of different ports of a network switch and different computers.

12. The apparatus of claim 10, wherein the scheduler is further adapted to further base the selective modification on communication requirements specified by a service level agreement.

13. The apparatus of claim 10, wherein the scheduler is further adapted to minimize a number of the hardware containers used in the determined configuration.

14. The apparatus of claim 10, further comprising a migration controller to migrate at least at least one of the plurality of virtual machines based on the determined configuration.

15. An article comprising a non-transitory computer readable storage medium to store instructions that when executed by at least one processor cause the at least one processor to:
provide a first candidate configuration for virtual machines specifying where the virtual machines are stored in a plurality of hardware containers;
determine a benefit gained by modifying the first candidate configuration to change a hardware container from the plurality of hardware containers where at least one of the virtual machines is stored based at least in part on communication capacities associated with the plurality of hardware containers;
selectively modify the first candidate configuration to generate a second candidate configuration specifying where the virtual machines are stored in the plurality of hardware containers based at least in part on the determined benefit; and
determine placement of the virtual machine based at least in part on the selective modification.
